(19) United States
(12) Patent Application Publication
(10) Pub. No.: US 2025/0162091 A1
(43) Pub. Date: May 22, 2025

(54) MANUFACTURING METHOD FOR USER INTERFACE DEVICE

(71) Applicant: KABUSHIKI KAISHA TOKAI RIKA DENKI SEISAKUSHO, Aichi (JP)

(72) Inventor: Yohei HASHIMOTO, Aichi (JP)

(73) Assignee: KABUSHIKI KAISHA TOKAI RIKA DENKI SEISAKUSHO, Aichi (JP)

(21) Appl. No.: 18/952,421

(22) Filed: Nov. 19, 2024

(30) Foreign Application Priority Data
Nov. 22, 2023 (JP) 2023-197856

(51) Int. Cl. B23P 19/04; G06F 3/041

(52) U.S. Cl. CPC B23P 19/04; G06F 3/041; G06F 2203/04103

(57) ABSTRACT

A manufacturing method for a user interface device. The user interface device includes an immovable portion, a movable portion, an operated member provided on one of the immovable portion and the movable portion, and an actuator provided on an other of the immovable portion and the movable portion, the actuator facing the operated member in a first direction via a first gap. The actuator being configured to apply an electromagnetic force to the operated member to displace the movable portion. The manufacturing method includes arranging the actuator and the operated member to face each other across a second gap, inserting a spacer into the second gap, displacing at least one of the operated member and the actuator, and removing the spacer.

### CROSS-REFERENCE TO RELATED APPLICATIONS

This application is based on and claims priority under 35 USC 119 from Japanese Patent Application No. 2023-197856 filed on Nov. 22, 2023, the entire content of which is incorporated herein by reference.

### TECHNICAL FIELD

The present disclosure relates to a manufacturing method for a user interface device and a manufacturing device for a user interface device.

### BACKGROUND ART

JP2018-156532A discloses a user interface device including an actuator provided on an immovable portion and an operated member provided on a movable portion so as to face the actuator with a gap interposed therebetween. The actuator is configured to attract the operated member by applying an electromagnetic force. The user interface device is configured such that the actuator repeatedly attracts and releases the operated member, causing the movable portion to vibrate and providing feedback to a user through the vibration.

### SUMMARY OF INVENTION

Aspect of non-limiting embodiments of the present disclosure relates to provide a manufacturing method for a user interface device that can precisely determine the dimension of the gap formed between the operated member and the actuator.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a manufacturing method for a user interface device,
the user interface device including:
   an immovable portion;
   a movable portion;
   an operated member provided on one of the immovable portion and the movable portion; and
   an actuator provided on an other of the immovable portion and the movable portion, the actuator facing the operated member in a first direction via a first gap,
the actuator being configured to apply an electromagnetic force to the operated member to displace the movable portion,
the manufacturing method including:
arranging the actuator and the operated member to face each other across a second gap, the second gap being wider in the first direction than the first gap in the first direction;
inserting a spacer into the second gap, the spacer having a dimension in the first direction the same as the first gap in the first direction;
in a state where the spacer is inserted into the second gap, displacing at least one of the operated member and the actuator in the first direction to sandwich the spacer between the operated member and the actuator; and
removing the spacer sandwiched between the operated member and the actuator.

### BRIEF DESCRIPTION OF DRAWINGS

Exemplary embodiment(s) of the present invention will be described in detail based on the following figures, wherein:

FIG. 1 illustrates a user interface device according to an embodiment;

FIG. 2 illustrates an operated member according to an embodiment;

FIG. 3 illustrates a manufacturing device for the user interface device according to the present embodiment;

FIG. 4 illustrates a manufacturing method for a user interface device according to the present embodiment;

FIG. 5 illustrates the manufacturing method for a user interface device according to the present embodiment;

FIG. 6 illustrates the manufacturing method for a user interface device according to the present embodiment;

FIG. 7 illustrates the manufacturing method for a user interface device according to the present embodiment;

FIG. 8 illustrates the manufacturing method for a user interface device according to the present embodiment;

FIG. 9 illustrates the manufacturing method for a user interface device according to the present embodiment; and

FIG. 10 illustrates another example of a method for displacing the operated member in a first direction.

### DESCRIPTION OF EMBODIMENTS

Hereinafter, embodiments will be described with reference to the accompanying drawings. In the drawings used in the following description, the scale is appropriately changed in order to make illustrated elements recognizable in size.

The expression “extending in a first direction” used in the present specification includes extending at an angle with respect to the first direction, and means extending at an angle closer to the first direction than a direction orthogonal to the first direction.

The expression “extending in a second direction” used in the present specification includes extending at an angle with respect to the second direction, and means extending at an angle closer to the second direction than a direction orthogonal to the second direction.

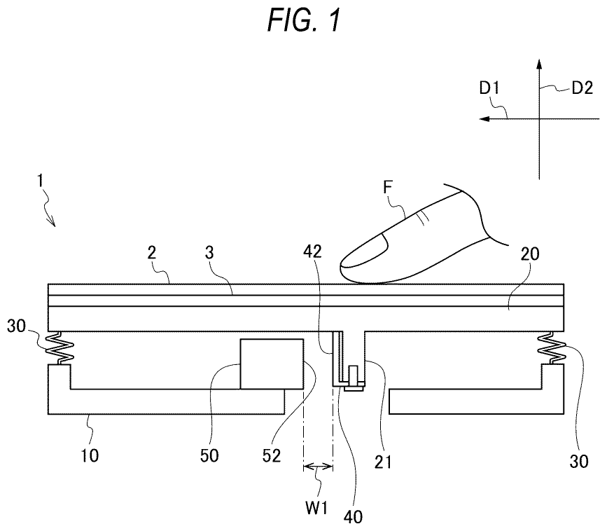

FIG. 1 illustrates a user interface device 1 according to an embodiment. The user interface device 1 is configured to provide feedback to a finger F or the like of a user by vibration when it detects that a predetermined operation is performed by the finger F or the like of the user.

The user interface device 1 includes an operation input unit 2. The operation input unit 2 forms a surface of the user interface device 1.

The user interface device 1 includes a detection unit 3. The detection unit 3 is configured to output a signal corresponding to a predetermined operation on the operation input unit 2 by the finger F of the user. A known method can be adopted as a method for the detection unit 3 to detect a predetermined operation by the finger F of the user. For example, a capacitance type, an optical type, a resistive film type, or the like may be adopted.

The user interface device 1 includes an immovable portion 10 and a movable portion 20. The movable portion 20 is configured to be displaced with respect to the immovable portion 10, in response to an operation on the operation input unit 2 by the finger F of the user.

The user interface device 1 includes an elastic member 30. The elastic member 30 is provided to connect the immovable portion 10 and the movable portion 20. The elastic member 30 enables the movable portion 20 to vibrate with respect to the immovable portion 10.

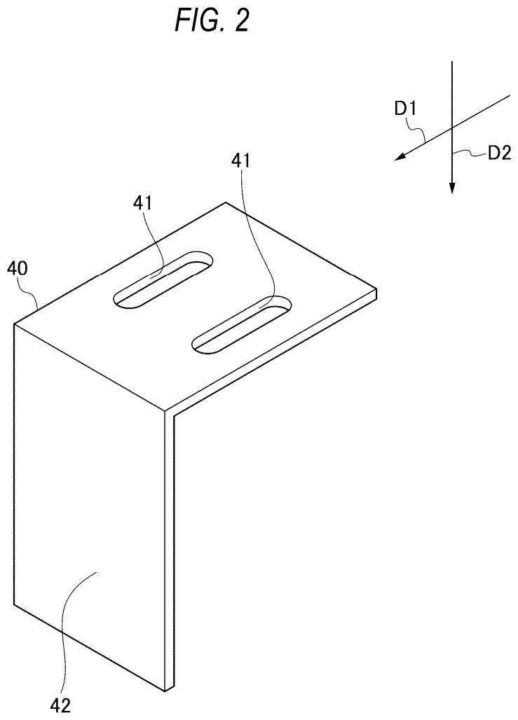

The user interface device 1 includes an operated member 40. FIG. 2 illustrates the operated member 40. As illustrated in FIGS. 1 and 2, the operated member 40 is provided on the movable portion 20. The operated member 40 is fixed to a protruding portion 21 formed on the movable portion 20. The operated member 40 is made of a magnetic material.

The user interface device 1 includes an actuator 50. A coil (not shown) is accommodated in the actuator 50. The actuator 50 is provided in the immovable portion 10.

As illustrated in FIG. 1, the actuator 50 is provided to face the operated member 40 in a first direction D1 via a first gap W1. The first gap W1 is a distance between the operated member 40 and the actuator 50 in a case where the actuator is not in operation.

The actuator 50 is configured to displace the movable portion 20 by applying an electromagnetic force to the operated member 40. In a case where a current flows through the actuator 50, the coil (not shown) incorporated in the actuator 50 generates a magnetic field. As a result, the operated member 40 and the actuator 50 are attracted to each other, and the actuator 50 and the movable portion 20 are displaced in the first direction D1. In a case where the current flowing through the actuator 50 stops, the magnetic field generated by the coil incorporated in the actuator 50 disappears. As a result, the force attracting the operated member 40 and the actuator 50 to each other disappears, and the movable portion 20 is returned to an original position due to the elastic member 30, so that the actuator 50 and the movable portion 20 are displaced in a direction opposite to the first direction. Therefore, by switching the current to the actuator 50 on and off, it is possible to vibrate the movable portion 20 with respect to the immovable portion 10.

In the user interface device 1 described above, it is desirable to reduce the first gap W1, which is the distance between the actuator 50 and the operated member 40. This is because, by reducing the distance between the actuator 50 and the operated member 40, it is possible to vibrate the movable portion 20 with respect to the immovable portion 10 even with a weak magnetic field, and the actuator 50 can be made smaller. Specifically, it is known that the force with which the actuator 50 attracts the operated member 40 is inversely proportional to the square of the dimension of the first gap W1.

However, by reducing the distance between the actuator 50 and the operated member 40, the error in the magnitude of the force applied to the operated member 40 by the actuator 50 based on the error from a specified distance becomes large. Therefore, when assembling the user interface device 1, it is necessary to precisely determine the first gap W1 which is the dimension of the gap formed between the operated member 40 and the actuator 50.

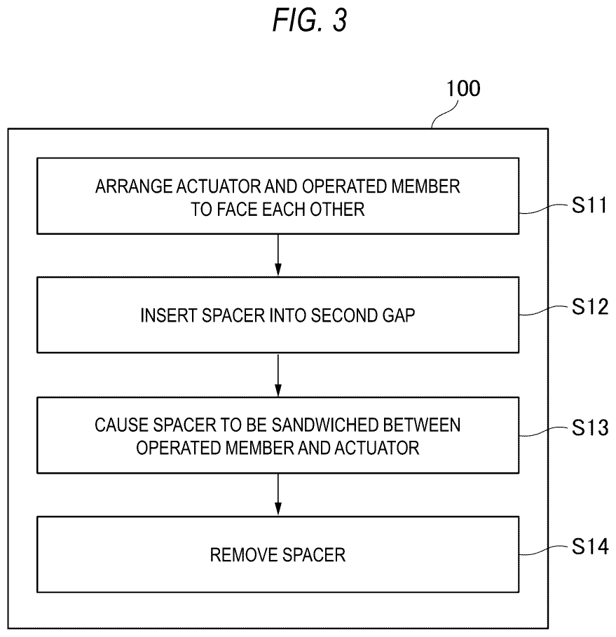

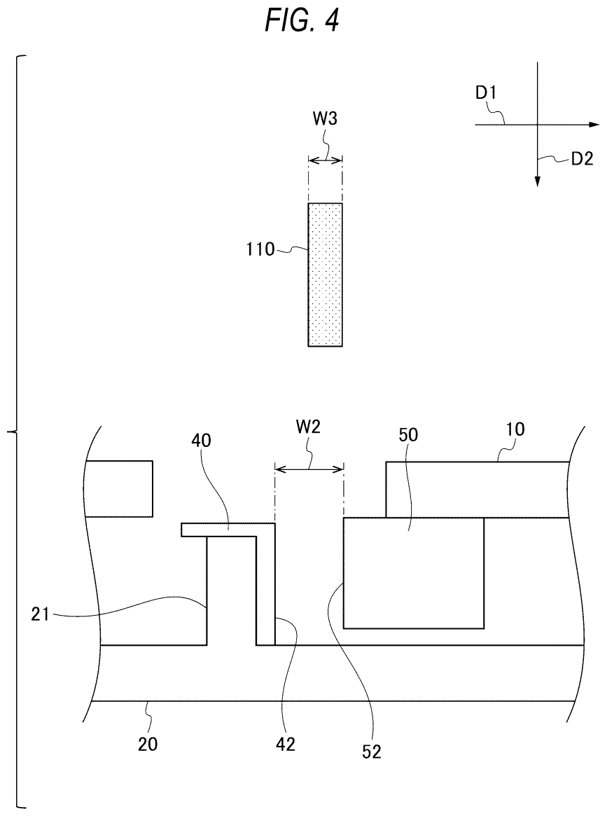

Next, a manufacturing method and a manufacturing device 100 for the user interface device 1 will be described. FIG. 3 illustrates the manufacturing device 100 for the user interface device 1 according to the present embodiment. FIGS. 4 to 9 illustrate the manufacturing method for a user interface device according to the present embodiment. As illustrated in FIG. 3, the manufacturing device 100 includes four steps S11 to S14. Steps S11 to S14 will be described with reference to FIGS. 4 to 9, respectively. In the present embodiment, the manufacturing device 100 and the manufacturing method for determining a dimension of a gap formed between the operated member 40 and the actuator 50 by fixing the operated member 40 to the movable portion 20 will be described. Therefore, the actuator 50 is already fixed to the immovable portion 10.

As illustrated in FIG. 4, the manufacturing device 100 arranges the actuator 50 and the operated member 40 to face each other across a second gap W2 that is wider in the first direction D1 than the first gap W1 in the first direction D1 (step S11 in FIG. 3).

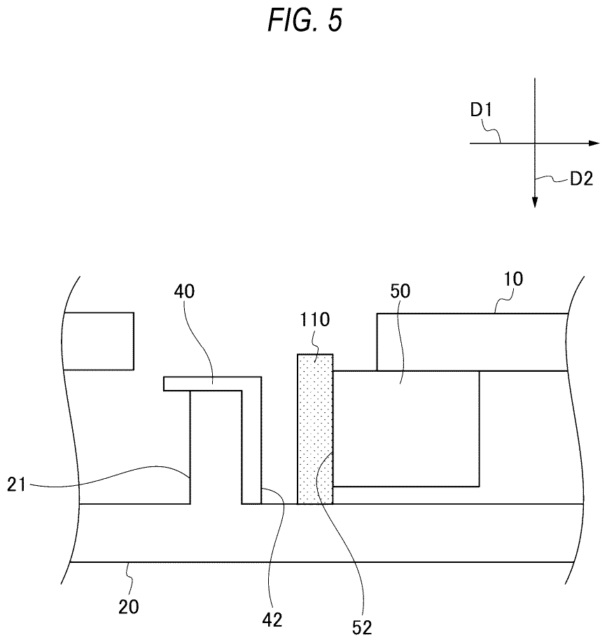

Next, as illustrated in FIG. 5, the manufacturing device 100 inserts a spacer 110 into the second gap W2 (step S12 in FIG. 3). As illustrated in FIG. 4, the spacer 110 has a dimension W3 in the first direction D1 that is the same as the first gap W1 that is specified by design.

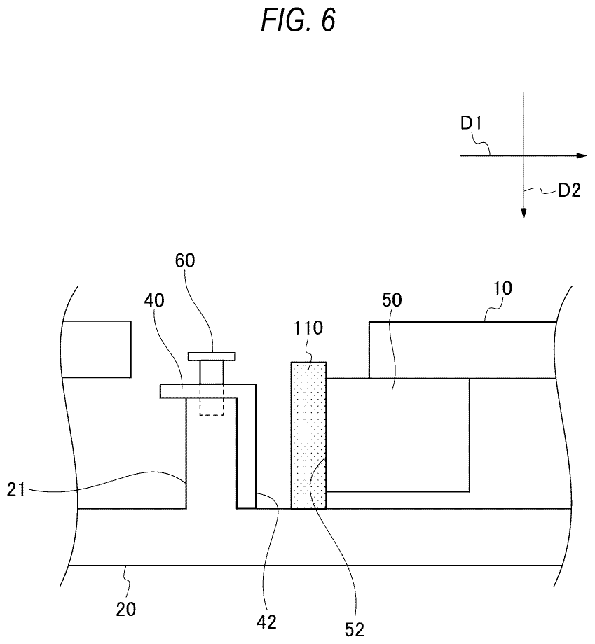

Next, as illustrated in FIG. 6, the manufacturing device 100 may temporarily fix the operated member 40 to the movable portion 20 such that the operated member 40 is not displaced in a direction intersecting the first direction D1. A method of temporarily fixing the operated member 40 will be described later.

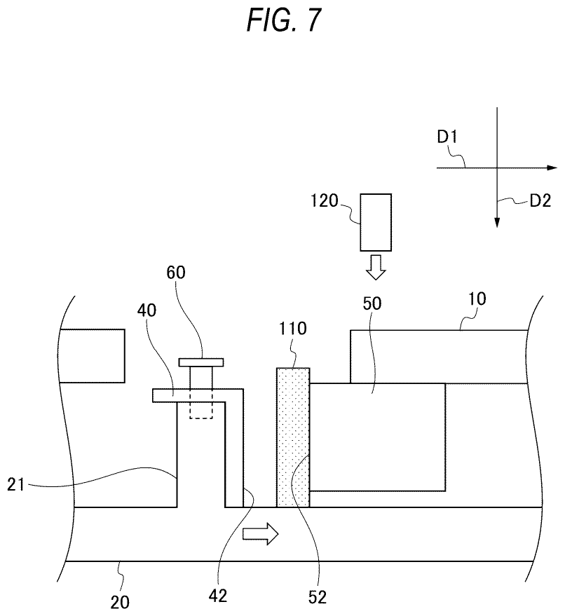

Next, as illustrated in FIG. 7, the manufacturing device 100 displaces the operated member 40 in the first direction D1 in a state where the spacer 110 is inserted into the second gap W2, thereby causing the spacer 110 to be sandwiched between the operated member 40 and the actuator 50 (step S13 in FIG. 3). A method by which the manufacturing device 100 displaces the operated member 40 in the first direction D1 will be described later.

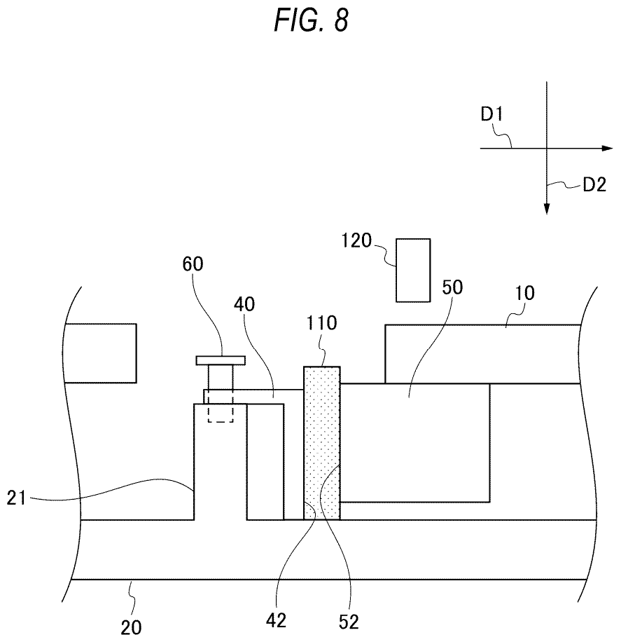

As illustrated in FIG. 8, in a case where the operated member 40 is displaced in the first direction D1, the operated member 40 and the actuator 50 are in close contact with the spacer 110. In other words, the spacer 110 is sandwiched between the operated member 40 and the actuator 50. At this time, the spacer 110 has the dimension W3 in the first direction D1 that is the same as the first gap W1, and the distance between the operated member 40 and the actuator 50 is the same dimension as the first gap W1.

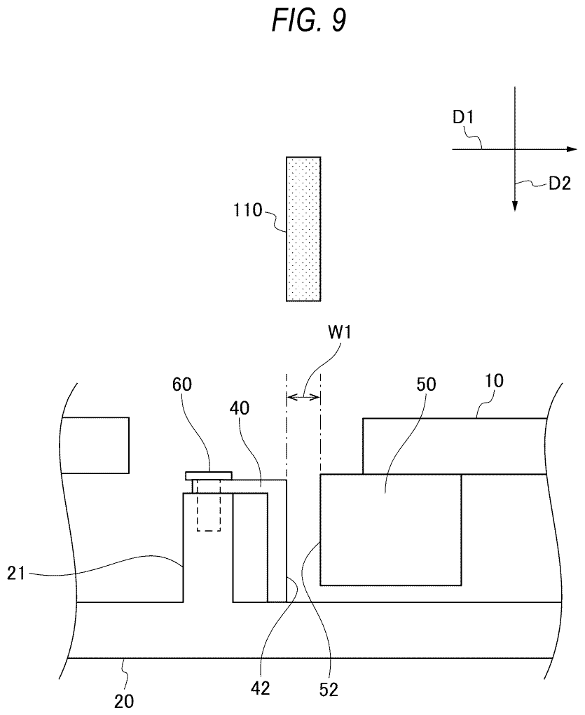

Next, as illustrated in FIG. 9, the manufacturing device 100 fixes the operated member 40 to the movable portion 20. By fixing the operated member 40 to the movable portion 20, the dimension between the operated member 40 and the actuator 50 is determined. A method of fixing the operated member 40 to the movable portion 20 will be described later.

As illustrated in FIG. 9, the manufacturing device 100 removes the spacer 110 sandwiched between the operated member 40 and the actuator 50 (step S14 in FIG. 3). The dimension of the gap between the operated member 40 and the actuator 50 formed by removing the spacer 110 corresponds to the predetermined first gap W1.

The operations of steps S11 to S14 included in the manufacturing method for the user interface device 1 are performed by the manufacturing device 100 in the present embodiment. However, steps S11 to S14 may be performed manually.

According to the manufacturing method and the manufacturing device 100 for the user interface device 1, the operated member 40 is displaced in the first direction D1 in a state where the spacer 110 inserted between the operated member 40 and the actuator 50. Therefore, the operated member 40 and the actuator 50 approach each other so that the second gap W2 between the operated member 40 and the actuator 50 becomes the first gap W1. In other words, the spacer 110 can separate the operated member 40 and the actuator 50 by the distance of the first gap W1. Accordingly, the dimension of the first gap W1, which is the gap formed between the operated member 40 and the actuator 50, can be precisely determined.

Returning to FIG. 7, a magnet 120 may be used as a method of displacing the operated member 40 in the first direction D1 by the manufacturing device 100. Specifically, in a case where the magnet 120 is brought close to the actuator 50, an induced electromotive force is generated in the coil incorporated in the actuator 50. As a result, the coil generates a magnetic field, and the operated member 40 is displaced in the first direction D1, which is a direction approaching the actuator 50.

According to the manufacturing method for an interface device described above, in a case where the magnet 120 is brought close to the actuator 50, the operated member 40 is displaced so as to approach the actuator 50. Therefore, there is no need to provide, between the immovable portion 10 and the movable portion 20 of the user interface device 1, a mechanism for applying a force to displace the operated member 40 in the first direction D1, so that the mechanism of the user interface device 1 during manufacture can be simplified.

When a technique is adopted in which the magnet 120 is brought close to the actuator 50, the spacer 110 inserted between the operated member 40 and the actuator is preferably made of a magnetic material. At this time, the force of displacing the operated member 40 in the first direction D1 becomes stronger by the induced electromotive force generated in the actuator 50, so that the operated member 40 is tightly attached to the spacer 110. Accordingly, the dimension of the gap formed between the operated member 40 and the actuator 50 can be precisely determined.

The method of temporarily fixing the operated member 40 to the immovable portion and the method of fixing the operated member 40 to the immovable portion will be described. In the present embodiment, as illustrated in FIG. 2, a long hole 41 extending in the first direction D1 is formed in the operated member 40. As illustrated in FIGS. 6 to 9, the manufacturing device 100 for the user interface device 1 is configured such that the operated member 40 is temporarily fixed or fixed to the movable portion 20 by fastening a fastening member.

The manufacturing method of the user interface device 1 may include inserting a fastening member 60 into the long hole 41 formed in the operated member 40 and extending in the first direction D1, thereby putting the operated member 40 into a state where the operated member 40 is configured to be displaced with respect to the movable portion 20. In other words, the operated member 40 may be temporarily fixed to the movable portion 20 by inserting the fastening member 60 into the long hole 41 formed in the operated member 40 and extending in the first direction D1.

As illustrated in FIG. 6, the fastening member 60 may be disposed so as not to sandwich the operated member 40 between the fastening member 60 and the movable portion 20, so that the operated member 40 may be temporarily fixed to the movable portion 20. At this time, since the fastening member 60 is inserted into the long hole 41 extending in the first direction D1, the operated member 40 is configured to be displaced in the first direction D1 with respect to the fastening member 60 and the movable portion 20.

The manufacturing method for the user interface device 1 may include fixing the fastening member 60 to the movable portion 20 in a state where the spacer 110 is sandwiched between the operated member 40 and the actuator 50. In the present embodiment, the operated member 40 is sandwiched by the fastening member 60 and the protruding portion 21 of the movable portion 20, so that the operated member 40 is fixed to the movable portion 20.

According to the manufacturing method for the user interface device 1 described above, the operated member 40 can be displaced in the first direction D1 by inserting the fastening member 60 into the long hole 41 formed in the operated member 40 and extending in the first direction D1. Further, by fixing the fastening member 60 to the movable portion 20 in a state where the spacer 110 is sandwiched between the operated member 40 and the actuator 50, the position of the operated member 40 can be determined. Thus, the configuration for precisely determining the dimension of the first gap W1, which is the gap formed between the operated member 40 and the actuator 50, can be simplified.

As illustrated in FIG. 1, the operated member 40 has a surface 42 extending in a second direction D2 that is orthogonal to the first direction D1 and that is a direction from the immovable portion 10 toward the movable portion 20. Similarly, the actuator 50 has a surface 52 extending in the second direction D2. Therefore, the operated member 40 and the actuator 50 have surfaces that face each other and are parallel to each other.

Therefore, as illustrated in FIG. 8, in a case where the operated member 40 is displaced in the first direction D1, the spacer 110 is sandwiched between the operated member 40 and the actuator 50, and the spacer 110 is brought into close contact with the surface 42 of the operated member 40 and the surface 52 of the actuator 50. Accordingly, the dimension of the first gap W1, which is the gap formed between the operated member 40 and the actuator 50, can be precisely determined.

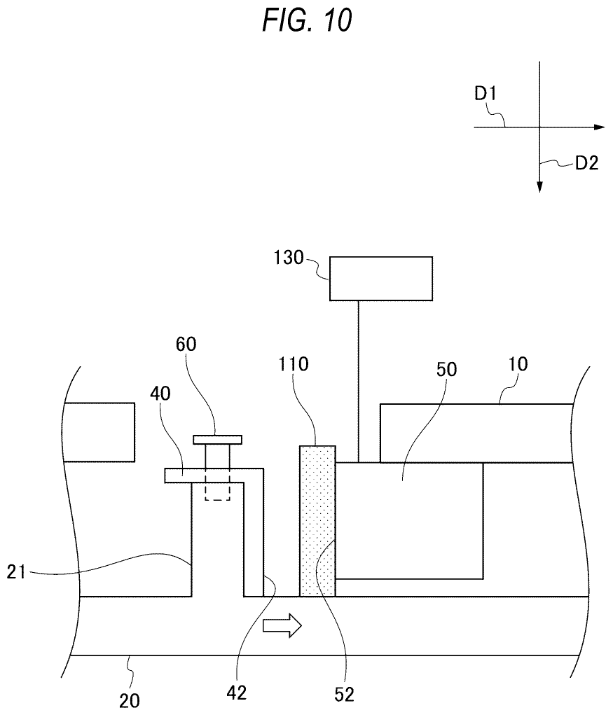

Next, another example of the method for displacing the operated member 40 in the first direction D1 will be described. FIG. 10 illustrates another example of the method for displacing the operated member 40 in the first direction D1. In this example, the actuator 50 is connected to a power source 130.

In a case where the operated member 40 is to be displaced in the first direction D1, electric power is supplied from the power source 130 to the actuator 50. In a case where electric power is supplied to the actuator 50, a magnetic field is generated around the actuator 50, and the operated member 40 is displaced in the first direction D1.

By displacing the operated member 40 in the first direction D1 in this manner, the configuration for precisely determining the dimension of the first gap W1, which is the gap formed between the operated member 40 and the actuator 50, can be simplified.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

In the above-described embodiment, the operated member 40 is provided on the movable portion 20. Alternatively, the operated member 40 may be provided on the immovable portion 10. At this time, the actuator 50 is provided in the movable portion 20.

In the above-described embodiment, the actuator 50 is already fixed to the immovable portion 10, and a process of fixing the operated member 40 to the movable portion 20 is described. However, in a case where the operated member 40 is already fixed to the movable portion 20, the manufacturing method and the manufacturing device 100 according to the present disclosure may also be adopted for a process of fixing the actuator 50 to the immovable portion 10.

In the above-described embodiment, a method using the magnet 120 and a method of passing a current through the actuator 50 by the power source 130 or the like are described as the method for displacing the operated member 40 in the first direction D1. Alternatively, the operated member 40 may be displaced in the first direction D1 by a method other than the above. For example, a method may be adopted in which the operated member 40 is gripped by a device or by hand and displaced in the first direction D1.

The configurations listed below also constitute a part of the present disclosure.

(1): A manufacturing method for a user interface device,
the user interface device including:
an immovable portion;
a movable portion;
an operated member provided on one of the immovable portion and the movable portion; and
an actuator provided on an other of the immovable portion and the movable portion, the actuator facing the operated member in a first direction via a first gap,
the actuator being configured to apply an electromagnetic force to the operated member to displace the movable portion,
the manufacturing method including:
arranging the actuator and the operated member to face each other across a second gap, the second gap being wider in the first direction than the first gap in the first direction;
inserting a spacer into the second gap, the spacer having a dimension in the first direction the same as the first gap in the first direction;
in a state where the spacer is inserted into the second gap, displacing at least one of the operated member and the actuator in the first direction to sandwich the spacer between the operated member and the actuator; and
removing the spacer sandwiched between the operated member and the actuator.

(2): The manufacturing method for the user interface device according to (1), further including:
displacing at least one of the operated member and the actuator in the first direction by bringing a magnet closer to the actuator.

(3): The manufacturing method for the user interface device according to (2),
wherein the spacer is formed of a magnetic material.

(4): The manufacturing method for the user interface device according to (1), further including:
displacing at least one of the operated member and the actuator in the first direction by passing a current through the actuator.

(5): The manufacturing method for the user interface device according to any one of (1) to (4), further including:
inserting a fastening member into a long hole that is formed in the operated member and that extends in the first direction to put the operated member into a state where the operated member is configured to be displaced with respect to the immovable portion or the movable portion; and
in a state where the spacer is sandwiched between the operated member and the actuator, fixing the fastening member to the immovable portion or the movable portion.

(6): The manufacturing method for the user interface device according to any one of (1) to (5),
wherein the operated member and the actuator have surfaces that face each other and that are parallel to each other.

(7): A manufacturing device for the user interface device that performs the manufacturing method according to any one of (1) to (6).

What is claimed is:

1. A manufacturing method for a user interface device,
the user interface device including:
an immovable portion;
a movable portion;
an operated member provided on one of the immovable portion and the movable portion; and
an actuator provided on an other of the immovable portion and the movable portion, the actuator facing the operated member in a first direction via a first gap,
the actuator being configured to apply an electromagnetic force to the operated member to displace the movable portion,
the manufacturing method comprising:
arranging the actuator and the operated member to face each other across a second gap, the second gap being wider in the first direction than the first gap in the first direction;
inserting a spacer into the second gap, the spacer having a dimension in the first direction the same as the first gap in the first direction;
in a state where the spacer is inserted into the second gap, displacing at least one of the operated member and the actuator in the first direction to sandwich the spacer between the operated member and the actuator; and
removing the spacer sandwiched between the operated member and the actuator.

2. The manufacturing method for the user interface device according to claim 1, further comprising:
displacing at least one of the operated member and the actuator in the first direction by bringing a magnet closer to the actuator.

3. The manufacturing method for the user interface device according to claim 2,
wherein the spacer is formed of a magnetic material.

4. The manufacturing method for the user interface device according to claim 1, further comprising:
displacing at least one of the operated member and the actuator in the first direction by passing a current through the actuator.

5. The manufacturing method for the user interface device according to claim 1, further comprising:
inserting a fastening member into a long hole that is formed in the operated member and that extends in the first direction, to put the operated member into a state where the operated member is configured to be displaced with respect to the immovable portion or the movable portion; and
in a state where the spacer is sandwiched between the operated member and the actuator, fixing the fastening member to the immovable portion or the movable portion.

6. The manufacturing method for the user interface device according to claim 1,
wherein the operated member and the actuator have surfaces that face each other and that are parallel to each other.

7. A manufacturing device for the user interface device that performs the manufacturing method according to claim 1.
